(19) United States
(12) Patent Application Publication
(10) Pub. No.: US 2010/0189446 A1
(43) Pub. Date: Jul. 29, 2010

(54) OPTICAL SIGNAL PROCESSING

(76) Inventors: Nicola Calabretta, Pisa (IT); Marco Presi, Pisa (IT); Giampiero Contestabile, Pisa (IT); Ernesto Ciaramella, Pisa (IT)

Correspondence Address: NIXON & VANDERHYE, PC, 901 NORTH GLEBE ROAD, 11TH FLOOR, ARLINGTON, VA, 22203, US

(21) Appl. No.: 12/520,624

(22) PCT Filed: Jan. 14, 2008
(86) PCT No.: PCT/IB2008/000616

§ 371 Date: Mar. 4, 2010

(30) Foreign Application Priority Data
Dec. 22, 2006 (GB) 0625543.4

(51) Int. Cl. H04B 10/06

(52) U.S. Cl. 398/202

(57) ABSTRACT

Optical signal processing apparatus for processing packetised optical signals comprising a probe signal generator which is arranged to issue a plurality probe pulses, and an optical AND logic gate assembly, the arrangement of the apparatus being such that, in use, the probe signals have an interval between pulses substantially equal to the interval between data elements of the packetised data to be extracted, and the packetised data and the probe pulses are then combined by the AND logic gate assembly.

### TECHNICAL FIELD

The present invention relates to optical signal processing.

### BACKGROUND

Internet-based telecommunication services constantly push the photonic industry to invest in high capacity systems. Differential phase shift keying (DPSK) wdm transmission systems, featuring higher robustness to nonlinear transmission impairments and lower required optical signal-to-noise ratio than the usual on-off keying (OOK) modulation format, recorded capacity of tens of tbit/s [1].

An optical packet switched (OPS) node based on all-optical circuits, with potentially higher speed operation and lower power consumption as compared to electronic circuits, is viewed as a viable solution to route such high-speed optical data packets. In devising an OPS node, a key function is the all-optical label processor (AOLS) that provides the forwarding information to route the packets to the destination node. Generally, the AOLS includes a label/payload separator (LPS) which extracts label data from the packet, and a serial-to-parallel conversion circuit (SPC) that parallelizes the label bits. The parallel bits can be then processed by fast CMOS electronics [2-5] or by self-routing all-optical circuit [6-8]. The all-optical processing can have the advantages of ultrafast operation and ease the node architecture by eliminating the implementation of an optical routing table.

Several solutions for all-optical parallelization of the label bits are disclosed in [4, 5, 9] and references therein. All those solutions are based on splitting and delaying the label data into N copies (with N the number of label bits), which are then sampled by a synchronous control pulse. Apart from the splitting losses and a number of active switches which linearly increase with the number of bits (making the system quite bulky and difficult to scale), the SPC requires a non-trivial pre-processing circuit (i.e. the LSP) which retrieves the synchronous optical sampling pulse. Moreover, some of these approaches do not operate in the C-band, are not suitable for photonic integration, depend on the state of polarization, and require high pump power. None of the references disclose processing of DPSK labelled packets.

One embodiment of the invention seeks to provide a solution to the serial-to-parallel label bits conversion that is scalable, asynchronous, with lower power consumption and is more cost effective than the known all-optical based solutions and faster than electrical based ones. The embodiment relies on a new paradigm, able to parallelize a large number of label bits only employing two optical functions

### SUMMARY

According to a first aspect of the invention we provide optical signal processing apparatus for processing packetised optical signals. The apparatus comprises a probe signal generator which is arranged to issue a plurality probe pulses, and an optical AND logic gate assembly The arrangement of the apparatus being such that, in use, the probe signals have an interval between pulses substantially equal to the interval between data elements of the packetised data to be extracted, and the packetised data and the probe pulses are then combined by the AND logic gate assembly.

According to a second aspect of the invention we provide a method of extracting data from packetised optical signals. The method comprises issuing a plurality of probe signals with an interval substantially equal to the interval between data elements of the packetised data to be extracted and combining the packetised data with the probe pulses by way of an optical AND logic gate assembly

In a highly preferred embodiment of the invention we provide a novel all-optical circuit which in use simultaneously extracts and parallelizes the label bits from DPSK packets. The technique employed by the circuit is based on converting the N serial label bits to N parallel label bits at distinct wavelengths. Advantages of this technique include the scalability with the number of label bits, and the asynchronous operation. Advantageously, the all-optical circuit can be realized by only two optical switches, independent of the number of bits, without resulting in large splitting losses and a large number of optical switches. The intrinsic asynchronous operation of the circuit eases the OPS node architecture eliminating the need of the LSP or a pre-processing circuit which provides the optical sampling pulse. Finally, it is highly preferred that the circuit is polarization independent, has low power consumption, is more compact than known assemblies, and can operate at very high bit-rate. An embodiment of the invention may be viewed as an asynchronous all-optical circuit for simultaneous extraction and serial-to-parallel conversion of label bits from optical DPSK packets based on time-to-wavelength conversion

### BRIEF DESCRIPTION OF THE DRAWINGS

Various embodiments of the invention will now be described, by way of example only, with reference to the following drawings in which:

FIG. 1 is a schematic representation of an optical processing arrangement, and

FIGS. 2(a) to 2(f) show traces of various signals in the optical processing arrangement of FIG. 1

### DETAILED DESCRIPTION

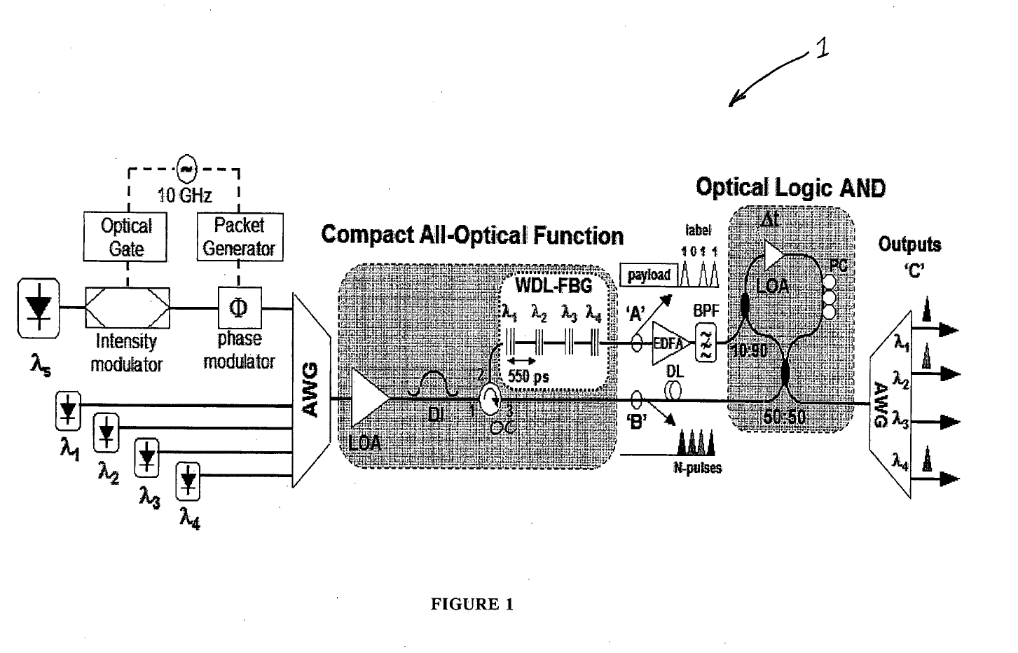

An optical processing arrangement 1 shown in FIG. 1 comprises two all-optical blocks or sub-assemblies: a compact all-optical function and an optical logic AND function. The compact function has as an input the DPSK packets and N Continuous Wave (CW) lightwaves produced by respective lasers (with N the number of label bits) and produces two synchronous outputs: the DPSK demodulated data packet (referenced ‘A’ in FIG. 1) and a sequence of N generated coloured pulses synchronous to the demodulated label bits (referenced ‘B’ in FIG. 1). The demodulated label bits and the synchronous N coloured pulses are fed into the optical logic AND gate. As a result, the label pattern will be transferred to the N coloured pulses. Thus, by using an arrayed Waveguide Grating (AWG) the coloured pulses can be separated in space at distinct outputs (referenced ‘C’ in FIG. 1), representing the parallel copy of the label pattern. The parallelized bits can be photo-detected and elaborated electrically or processed all-optically.

The compact all-optical function shown in FIG. 1 comprises a linear optical amplifier LOA and a one-bit delay interferometer DI, followed downstream by a wavelength-dependent delay line (WDL) [7]. The incoming DPSK packets are multiplexed by an AWG (which serves as a wavelength-multiplexer) with the N local CW lightwaves and fed into the optical circuit. The LOA combined with the DI acts as an optical switch [10], where the packet acts as the pump and the CW lightwaves as probes. In the LOA, the constant-envelope DPSK packet induces a cross-phase modulation on all the CW probes proportional to the packet intensity. Passing through the DI, the phase modulated CW probes are converted to amplitude modulation. As light emerges at the DI output only if the signal and the one-bit delayed signal have significantly different phase, N coloured pulses synchronous with the beginning of the packet and with the end of the packet are formed at the rise and fall edges of the packet. Simultaneously the DI also demodulates the original DPSK label packet. The demodulated DPSK packet and the synchronized N coloured pulses at the DI output are fed into the WDL. The WDL comprises Fibre Bragg Gratings (FBGs) which are centred at each wavelength of the laser probes and are placed at multiple distances so that the reflected coloured pulses form a sequence of N pulses with a pulse repetition equal to the label pulse repetition. Thus, the reflected coloured pulse sequence emerges at the port 3 of the optical circulator OC. The demodulated DPSK packets being at a different wavelength to the FBGs pass through the FBGs. As a result, the outputs of the compact function, A and B, consist of the demodulated DPSK label and the sequence of N-coloured pulses. Output A passes through a Ebrium Doped Fibre Amplifier EDFA and a Bandpass Filter BPF before being input into the optical AND function.

The optical logic AND function comprises a terahertz optical asymmetric demultiplexer (TOAD) [11]. As shown in FIG. 1 the TOAD consists of an optical loop containing as a nonlinear element another LOA, which is placed with an offset Δt with respect to the centre of the loop. The control pulse is coupled into the loop via a 90:10 coupler. The control pulse opens a switching window of 2 Δt. When an optical input pulse enters the TOAD, the pulse power is split by a 50:50 coupler into a clock-wise pulse (CW) and counter-clockwise pulse (CCW). If no control pulse is applied, the CW- and CCW pulses propagating through the loop recombine in phase at the coupler and then the resulting pulse is reflected back at the input port. If a control pulse arrives at the LOA after the CW pulse has passed through but before the CCW pulse arrives at the LOA, the CCW pulse experiences a different gain and refractive index induced by the control pulse. At the coupler, the CW- and CCW pulses recombine out of phase, thus the pulse is switched at the TOAD output [11]. Note that the time required by the TOAD to switch the next pulse (the switching repetition) is determined by the recovery time of the LOA [11]. Therefore, in the case of switching a sequence of pulses the employed LOA should have a recovery time faster than the pulse rate. The optical logic AND between the sequence of N pulses (as TOAD input) and the demodulated label bits (as control signal) is simply obtained at the output of the TOAD by filtering out the control signal.

Note that, since the coloured sequence contains only a number of pulses equal to the label bits, the AND operation between the payload and the remainder of the sequence does not produce any pulse. For the same reason, since the N-pulses sequence produced at the packet end falling within the packet's guard time, the AND operation between those N pulses and the packet's guardtime produces no pulse as well.

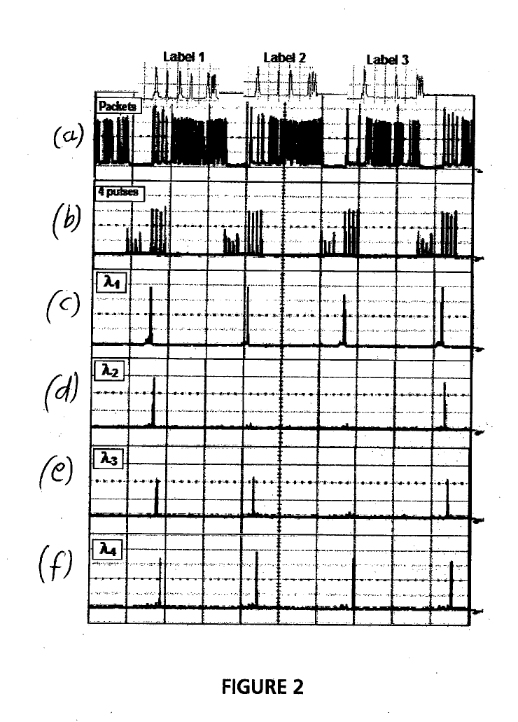

Details of an exemplary set-up of the arrangement of FIG. 1 are as follows. A CW laser at 1538.9 nm is modulated by an intensity modulator acting as optical gate to generate packets with guard-time of 3.2 ns. Then a LiNbO₃ phase modulator driven by a pattern generator (PG) at 10 Gbit/s was used to modulate the packets. A programmed sequence of three packets with different labels was periodically produced by the PG. The three labels consisting of four bits each had a pattern of L₁=‘1 1 1 1’, L₂=‘1 0 1 1’, and L₃=‘1 0 0 1’, respectively. Note that the repetition of the label bits is of 550 ps to match the delays imposed by the FBGs based WDL. Four CW lasers (from λ₁=1557.34 nm to λ₄=1559,77 nm, spaced by 0.8 nm) were coupled with the packet and fed into the compact function. The total power of the four probes and the power of the DPSK packets at the LOA input were 4 dBm and 5.8 dBm, respectively. The LOA had a 14 dB of small-signal gain and saturation output power of ˜10 dBm at 240 mA, a polarization dependent gain 1.4 dB, and a gain recovery time of around 100 ps. Note that exploiting the higher saturation power of the LOA allows the increase of the probes power and then a higher power of the converted signal or equivalently increasing the number of probes [10]. The bit-delay in the DI was 100 ps to demodulate the DPSK 10 Gbit/s packets. The FBGs in the WDL centred at the CWs wavelength introduced an integer multiples of 550 ps wavelength dependent delay to generate a sequence of pulses with a repetition equal to the label bit-rate. The demodulated DPSK packets after the DI are shown in FIG. 2a, where the three different labels with pattern L₁, L₂, and L₃, can be seen. The 4-pulse sequences generated at the beginning and at end of each packet (we recall that only the sequences at the beginning are relevant) are shown in FIG. 2b. The magnification of the 4-coloured pulses is also shown. The pulses are positioned at integer multiples of 550 ps as expected. The measured extinction ratio of the pulses is around 14 dB. The demodulated DPSK bits were amplified by an EDFA and filtered by a band pass filter (BPF) before to be fed into the TOAD via a 10:90 coupler. The 4-pulses were delayed by a fixed delay line (DL) to compensate the longer path experienced by the demodulated DPSK signal and then fed into the TOAD. The average optical power of the demodulated signal after the 10:90 coupler and the 4-pulses is 3.3 dBm and −10 dBm, respectively.

The LOA in the TOAD has similar characteristic of the LOA in the Compact All-Optical Function. The driving current is 180 mA. The TOAD switching window is around 80 ps. The output of the TOAD is demultiplexed by the AWG, which outputs λ₁, . . . , λ₄ representing the parallel bits are shown in FIGS. 2c-2f. Indeed, it can be clearly seen that for packets with label L₁ (‘1 1 1 1’) a pulse appears at the four outputs, while for packets with L₂ (‘1 0 1 1’) only λ₁, . . . , λ₃ and λ₄ present a pulse, and finally for packets with L₃ (‘1 0 0 1’) a pulse appears only for λ₁ and λ₄. The measured extinction ratio of pulses is around 12 dB. Thus, those results provide evidences that the serial label bits are converted to parallel output ports.

The novel asynchronous all-optical circuit advantageously simultaneously extracts and parallelizes the label bits of DPSK packets. As the main advantage of the technique, it requires only two optical switch assemblies. Parallelization of a high number of bits just requires a higher number of CW lightwaves and FBGs with no substantial modification of the setup. Moreover, the use of only two switches hugely reduces the power consumptions and the potential complexity for photonic integration of the circuit.

The operation described above employed 10 Gbit/s data packets. However, circuit operation at much higher bit rate is feasible as the technique is sensitive only to the (constant) envelope of the DPSK signal, which makes the function bit-rate transparent, and, as it is well known, the TOAD can operate at very high bit rate [11]. Moreover, the circuit being asynchronous no synchronization circuit for packet/bit is needed, reducing the complexity of the cross-connect node. Finally, the circuit is polarization independent and can in principle work also with OOK packets by adding an optical packet envelope detector pre-processor.

### Abbreviations

AOLS All-Optical Label Processor
BPF Band Pass Filter
CMOS Complementary Metal-Oxide Semiconductor
CW Continuous Wavelength
DI Delay Interferometer
DL Delay Line
DPSK Differential Phase Shift Keying
EDFA Erbium Doped Fiber Amplifier
FBG Fiber Bragg Grating
LPS Label/Payload Separator
LOA Linear Optical Amplifier
OC Optical Circulator
OOK On-Off Keying
OPS Optical Packet Switched node
PG Pattern Generator
SPC Serial-to-Parallel Conversion circuit
TOAD Terahertz Optical Asymmetric Demultiplexer
WDL Wavelength-dependent Delay Line
WDM Wavelength Division Multiplexing

### REFERENCES

[1] A. H. Gnauck, P. J. Winzer, ‘Optical phase-shift-keyed transmission,’ IEEE Journal of Lightwave Technology, vol. 23, pp. 115-130, 2005.
[2] D. Klonidis, C. T. Politi, R. Nejabati, M. J. O'Mahony, D. Simeonidou, ‘OPSnet: design and demonstration of an asynchronous high-speed optical packet switch,’ IEEE Journal of Lightwave Technology, vol. 23, pp. 2914-2925, 2005.
[3] K. G. Vlachos, I. T. Monroy, A. M. J. Koonen, C. Peucheret, and P. Jeppesen, ‘STOLAS: switching technologies for optically labeled signals,’ IEEE Communication Magazine, vol. 41, pp. S9-S15, 2003.
[4] K. Chan, F. Tong, C. K. Chan, L. K. Chen, W. Hung, ‘An all-optical packet header recognition scheme for self-routing packet networks,’ OFC 2002, pp. 284-285, 2002.
[5] R. Takahashi, T. Nakahara, H. Takenouchi, and H. Suzuki, ‘40-Gbit/s label recognition and 1×4 self-routing using self serial-to-parallel conversion,’ Photonics Technology Letters, vol. 16, pp. 692-694, 2004.
[6] N. Calabretta, A. D'Errico, G. Contestabile, E. Ciaramella, ‘All-optical label processing techniques for pure DPSK optical packets,’ IEEE Journal of Selected Topics in Quantum Electronics, vol. 12, pp. 686-696, 2006.
[7] N. Calabretta, G. Contestabile, E. Ciaramella, ‘A novel all-optical header processing system based on time-to-wavelength conversion for pure DPSK packets,’ Electronics Letters, 2005, 41, pp. 865-866.
[8] J. Kurumida, H. Uenohara, and K. Kobayashi, ‘All-optical label recognition with SOA-MZI multistage switching scheme,’ OFC 2006, JThB51, Anaheim, 2006.
[9] K. Ema, J. Ishi, H. Kunugita, T. Ban, and Kondo, ‘All-optical serial-to-parallel conversion of Tbits/s signals using a four-wave-mixing process,’ Optical Quantum Electronics, vol. 33, pp. 1077-1087, 2001.
[10] J. L. Pleumeekers, J. Leuthold, M. Kauer, P. G. Bernasconi, C. A. Burrus, M. Cappuzzo, E. Chen, L. Gomez, and E. Laskowsky, ‘All-optical wavelength conversion and broadcasting to eight separate channels by a single semiconductor optical amplifier delay interferometer,’ OFC 2002, Anaheim, pp. 596-597, 2002.
[11] J. P. Sokoloff, P. R. Prucnal, I. Glesk, and Kane, ‘A Terahertz optical asymmetric demultiplexer (TOAD),’ Photonics Technology Letters, vol. 5, pp. 787-790, 1993.

1. Optical signal processing apparatus for processing packetised optical signals comprising a probe signal generator which is arranged to issue a plurality probe pulses, and an optical AND logic gate assembly, the arrangement of the apparatus being such that, in use, the probe signals have an interval between pulses substantially equal to the interval between data elements of the packetised data to be extracted, and the packetised data and the probe pulses are then combined by the AND logic gate assembly.

2. Apparatus as claimed in claim 1 in which the probe signal generator comprises a plurality of lightwave sources, each of a different wavelength.

3. Apparatus as claimed in claim 2 in which light from each of the lightwave sources is phase modulated and then amplitude modulated so as to produce the probe pulses.

4. Apparatus as claimed in claim 3 which comprises a Fibre Bragg Grating arrangement which, in use, causes the pulses to have the interval substantially equal to the interval between data elements of the packetised data.

5. Apparatus as claimed in claim 4 in which the Fibre Bragg Grating arrangement comprises a plurality of Fibre Bragg Gratings, each Grating being arranged to select a particular wavelength each corresponding to a wavelength of each of the probe pulses, and the Fibre Bragg Gratings being suitably spaced relative to each other to space the pulses by the interval.

6. Apparatus as claimed in claim 1 which is arranged to demodulate the data elements of the packetized data.

7. Apparatus as claimed in claim 6 which is arranged to demodulate label data of the packetized data.

8. Apparatus as claimed in claim 1 in which the AND logic gate assembly comprises an optical loop arrangement which comprises a nonlinear optical device, the device being positioned offset from the centre of the path defined by the loop.

9. Apparatus as claimed in claim 1 in which the number of pulses is equal to the number of data elements to be extracted.

10. A method of extracting data from packetised optical signals, the method comprising issuing a plurality of probe signals with an interval substantially equal to the interval between data elements of the packetised data to be extracted and combining the packetised data with the probe pulses by way of an optical AND logic gate assembly.
